(19) United States
(12) Patent Application Publication
(10) Pub. No.: US 2010/0135742 A1
(43) Pub. Date: Jun. 3, 2010

(54) Enclosed Shipping Platform

(76) Inventor: Bernard Sain, Jacksonville, FL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/607,424

(22) Filed: Oct. 28, 2009

Related U.S. Application Data
(63) Continuation-in-part of application No. 12/419,725, filed on Apr. 7, 2009.
(60) Provisional application No. 61/071,654, filed on May 9, 2008.

(51) Int. Cl. B60P 7/06; B65D 88/12; B60P 3/07; B60P 1/64

(52) U.S. Cl. 410/46

(57) ABSTRACT

An enclosed shipping platform for transporting over-dimensional items, adapted for stacking above or below the decks of container ships on top of standard sized ISO cargo containers. The enclosed shipping platform has a base, walls, roof, and load-bearing end door frames. The enclosed shipping platform is wider than a standard ISO shipping container. The base has transverse end beams that are sufficiently rigid to allow the enclosed shipping platform to be mounted atop the corner posts of the standard ISO shipping container and support that portion of the enclosed shipping platform that extends beyond the width of the ISO shipping container.

### CLAIM OF PRIORITY

This application is a continuation in part of U.S. patent application Ser. No. 12/419,725, filed Apr. 7, 2009, which claims priority from U.S. Provisional Patent Application Ser. No. 61/071,654, filed on May 9, 2008, each of which is incorporated herein by reference.

### FIELD OF THE INVENTION

This application relates to shipping platforms for transporting cargo on container ships, and more specifically to an oversized shipping platform for transporting large vehicles and other over-dimensional items, adapted for stacking above or below the decks of container ships. Examples of shipping platforms are disclosed in U.S. Pat. Nos. 6,533,510; 7,011,479; 7,040,848; and 7,140,821, all of which are incorporated herein by reference.

### BACKGROUND OF THE INVENTION

The holds of modern container ships are usually constructed to receive ISO (International Standards Organization) containers that measure 40 feet in length, by 8 feet in width, by 8 feet 6 inches in height. The holds have bulkheads, spaced about 40 feet apart, that extend laterally from port to starboard. These bulkheads are provided with vertically extending cells that are sized to permit the 40 feet by 8 feet ISO containers to be slid down between protruding, vertically extending T-shaped cell guide members, which define the width of the cells. The number and depth of the cells, as well as the thickness of the T-shaped cell guide members, depend on the vessel class and age. With this construction, the containers can be secured against both rolling and pitching of the container ship. After a hold is filled with the ISO containers, a cover may be placed over the hatch to close the hold. Containers then can be stacked above deck, over the hatches.

Stacked ISO containers typically are joined together by twist-lock devices that engage the apertures of twist-lock corner castings of adjacent containers. The containers bear the considerable weight of superposed containers by virtue of the columnar strength of their robust corner posts, which are vertically aligned with others in the stack of standard ISO containers.

Containers wider than 8 feet also are used on container ships. These containers, too, have robust corner posts. Shipping platforms of the type disclosed in the aforementioned patents also may be wider than ISO containers, e.g., 12 feet wide, and also have robust vertical load-bearing frames, which may be adjustable in height depending on load height, and foldable for compactness when no load is carried. If a wider container or a wider shipping platform were to be placed on a stack of 8 feet wide ISO containers, not all of the corner posts or load-bearing frames would be aligned. In order to avoid improper load distribution, one must resort to interposing separate stacking devices between the diverse cargo layers, such as the stacking devices disclosed in U.S. Pat. Nos. 6,027,291 and 6,793,448, both of which are incorporated herein by reference. Such stacking devices properly transfer the load of the wider containers or shipping platforms to the corner posts of the 8 feet wide ISO containers.

### SUMMARY OF THE INVENTION

The shipping platform of this invention, which is wider than 8 feet, obviates the need for stacking devices when platforms of this type are to be stacked on 8 feet wide ISO containers, either above deck or below in cargo holds (although such stacking devices may still be used, if desired). When used below deck, the shipping platform of the present invention spans more than one cell in the hold, and the shipping platform's robust construction enables the shipping platform partially to overhang an adjacent and underlying ISO container without sagging and without loading the adjacent and underlying ISO container improperly. The shipping platform has a base with a cargo floor that preferably is sloped at both ends to facilitate the loading and unloading of wheeled cargo. The shipping platform of the present invention also has a robust, upright load-bearing frame at each end (“end frame”), which may be foldable parallel to the cargo floor for compactness when the shipping platform is empty and is to be moved about or stowed in that folded condition. The end frames optionally can be adjustable in height. Strategically placed twist-lock apertures enable connection of the shipping platform to adjacent shipping platforms or to ISO containers in the same or in an adjacent stack; and they serve as lift points for a gantry crane or other conventional types of lift equipment for handling the shipping platform when the end frames are upright or folded. Optional fork lift pockets in the base also facilitate handling of the shipping platform.

Preferably the shipping platform of the present invention is about 12 feet wide so that it can span one-and-one-half 8 feet wide ISO containers. Consequently, when two such 12 feet wide shipping platforms are placed side by side (totaling 24 feet in width), the 12 feet wide shipping platforms can exactly span three side-by-side 8 feet wide ISO containers. The preferred height of the shipping platform is about 12 feet, 9 inches (with end frames upright), making the shipping platform one-and-one-half times the height of a low-cube ISO container, which is 8 feet, 6 inches high. As a result, the combined height of two stacked shipping platforms (25 feet, 6 inches) equals the combined height of three stacked low-cube ISO containers. Further, the preferred height of a folded shipping platform is about 4 feet, 3 inches at the corners, which is half the height of an ISO container, so that the combined height of two folded and stacked shipping platforms equals the height of one low-cube ISO container. These width and height dimensions for the shipping platform thus facilitate close-packed configurations of shipping platforms and ISO containers, maximizing space utilization. The length of the shipping platform preferably is about 40 feet so that it can fit in the holds of modern container ships and engage the T-shaped cell guide members on the bulkheads of the hold. Cell guide slots at appropriate locations on each end of the shipping platform are provided for this purpose. The shipping platform may be longer than 40 feet if used only above deck. Built-in lashing points around the perimeter of the shipping platform facilitate securing the cargo to the shipping platform.

Further objects, features and advantages will become apparent upon consideration of the following detailed description of the invention when taken in conjunction with the drawings and the appended claims.

### BRIEF DESCRIPTION OF THE DRAWINGS

FIG. 1 is a corner perspective view of an open shipping platform constituting a first embodiment of the present invention.

FIG. 2 is an end perspective view of the open shipping platform of FIG. 1.

FIG. 3 is a top plan view of the base of the open shipping platform of FIG. 1, with a portion of the cargo floor cut away and the end frames removed for clarity.

FIG. 4 is a longitudinal sectional view of the base taken along line 4-4 in FIG. 3.

FIG. 5 is a transverse sectional view of the base taken along line 5-5 in FIG. 3.

FIG. 6 is a detail sectional view of one end beam of the base taken along 6-6 in FIG. 3.

FIG. 7 is a front elevation view of an end frame of the open shipping platform of FIG. 1.

FIG. 8 is a side elevation view of the end frame of FIG. 7.

FIG. 9 is a top plan view of the end frame of FIG. 7.

FIG. 10 is an end elevation view of the open shipping platform of FIG. 1, showing the end frame in a upright position and two side brace frames swung inwardly and tied together.

FIG. 11 is a composite side elevation view of the open shipping platform of FIG. 1, showing an upright end frame on the right side, and showing a folded end frame on the left side with another shipping platform and folded end frame stacked thereon.

FIG. 12 is a perspective view of two 12 feet wide shipping platforms according to the invention (with end frames folded) stacked atop two adjacent and underlying 8 feet wide ISO containers, with the upper shipping platform engaged by a gantry crane.

FIG. 13 is an end perspective view of several stacks of 8 feet wide ISO containers and 12 feet wide shipping platforms according to the invention in the hold of a ship.

FIG. 14 is an end perspective view, similar to FIG. 13, showing a different arrangement of ISO containers and shipping platforms.

FIG. 15 is a close-up of a portion of FIG. 13, showing the shipping platform's cell guide openings in alignment with those of the containers.

FIG. 16 is a corner perspective view showing the manner in which 8 feet wide ISO containers and 12 feet wide shipping platforms according to the invention can be securely disposed in the hold of a container ship.

FIG. 17 is a perspective view of an enclosed shipping platform constituting a second embodiment of the present invention.

FIG. 18 is a perspective view of the end door frame of the enclosed shipping platform of FIG. 17.

FIG. 19 is a top plan view of the enclosed shipping platform of FIG. 17.

FIG. 20 is a side elevation view of the enclosed shipping platform of FIG. 17.

FIG. 21 is an end perspective view of the door frame of the enclosed shipping platform of FIG. 17 with the doors closed.

FIG. 22 is an end perspective view of the door frame of the enclosed shipping platform of FIG. 17 with the doors open.

FIG. 23 is a perspective view of an enclosed shipping platform with a movable side panel.

FIG. 24 is a perspective view of the end door frame of the enclosed shipping platform of FIG. 23.

FIG. 25 is a top plan view of the enclosed shipping platform of FIG. 23.

FIG. 26 is a side elevation view of the enclosed shipping platform of FIG. 23 showing a partially open movable side panel.

### DETAILED DESCRIPTION OF THE PREFERRED EMBODIMENT

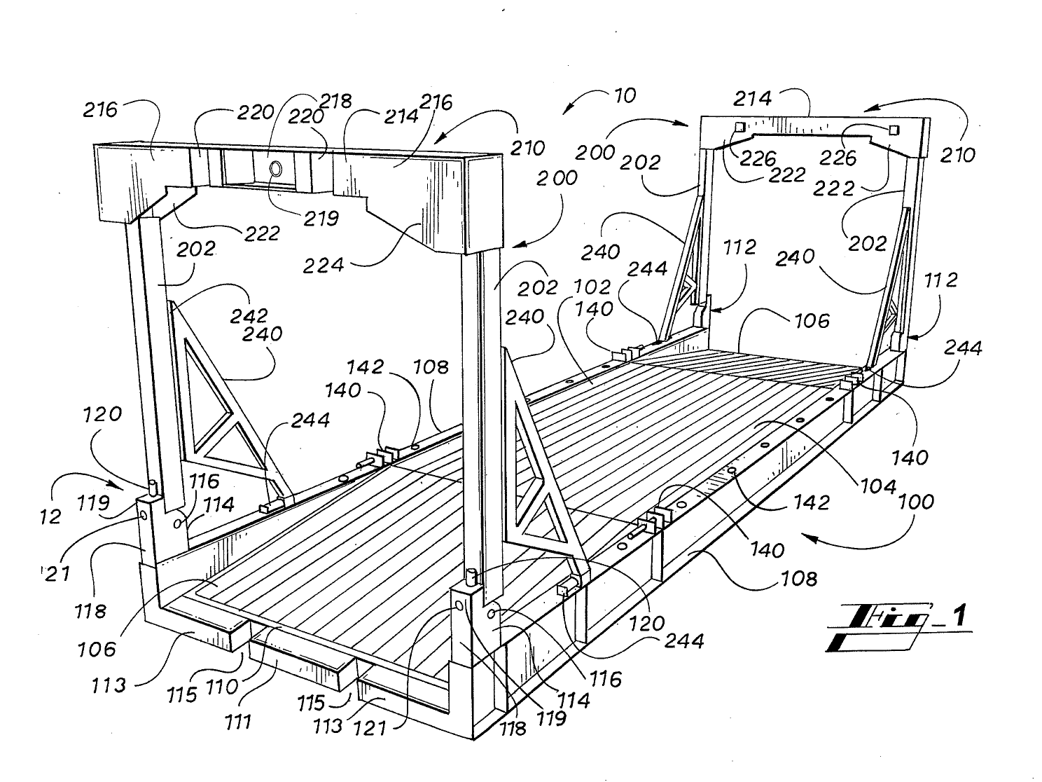

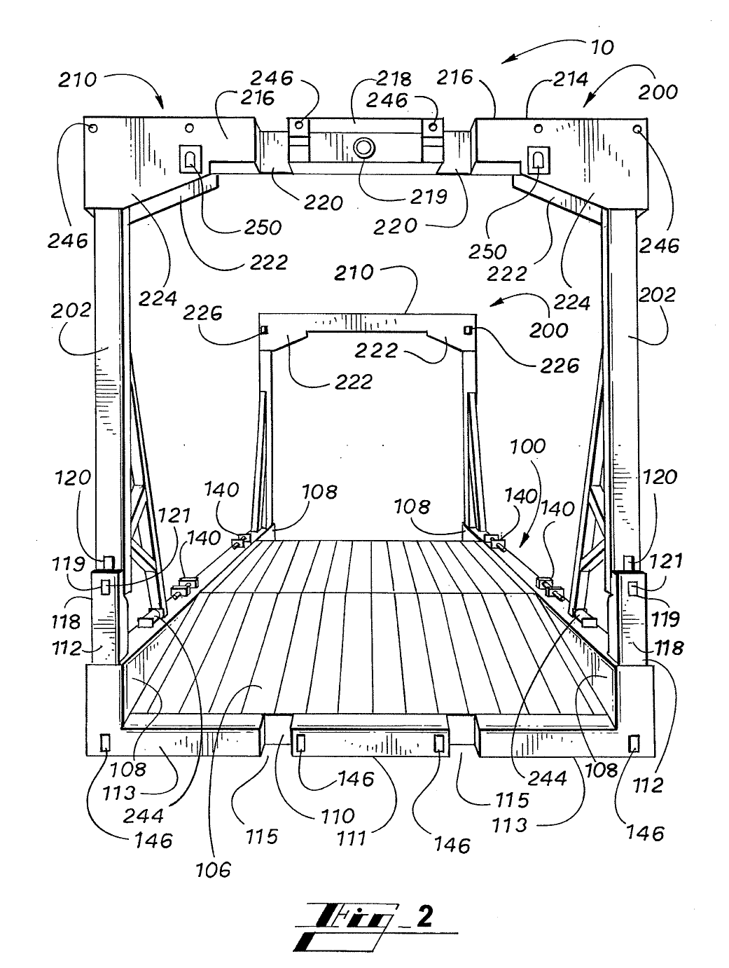

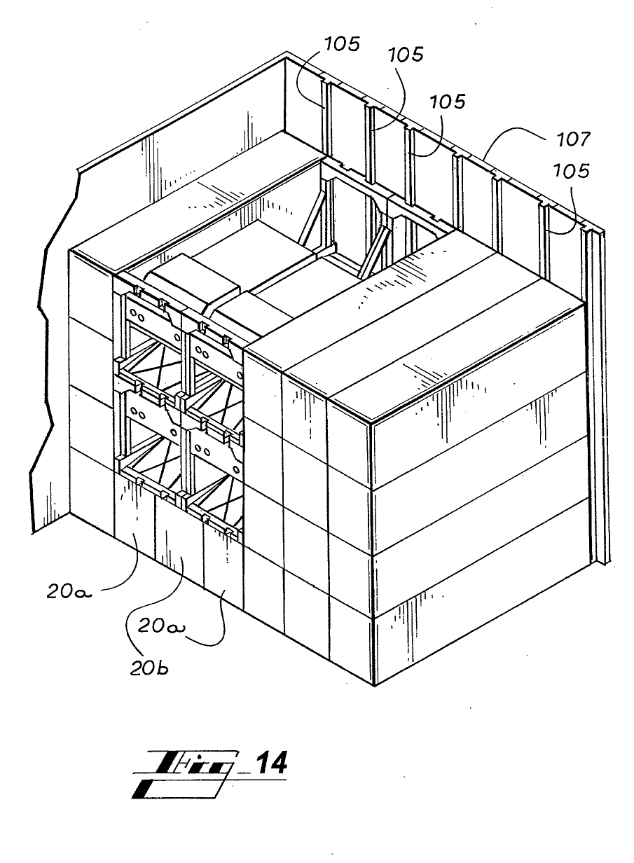

Referring to FIGS. 1 and 2, a 12 feet wide by 40 feet long open shipping platform 10 according to the invention generally comprises a base 100 and two end frames 200 that are hinged to the base. The base 100 comprises a cargo floor 102 having a central flat section 104 and sloping end sections 106 at opposite ends of the central flat section 104. The structural perimeter of the base 100 is comprised of I-beam type, web-reinforced side rails 108, and robust tubular end beams 110 welded to the side rails 108. A center sloped projection 111 and two side sloped projections 113 are welded to the front face of each box tubular end beam 110 and define two cell guide slots 115 that are spaced and sized such that one slot 115 on each end of the open shipping platform 10 will always engage a T-shaped cell guide member 105 on a bulkhead 107 in the hold of a cargo ship (FIGS. 13-16). Specifically, for this 12 feet wide open shipping platform 10, the cell guide slots 115 are about 12 inches deep, about 12 inches wide, and about 5 feet on center to accommodate variations in the location and thickness of the T-shaped cell guide members 105 on the bulkheads 107. The sloped top surfaces of side sloped projections 113 are rough to maximize traction as a vehicle is driven up onto the cargo floor 102.

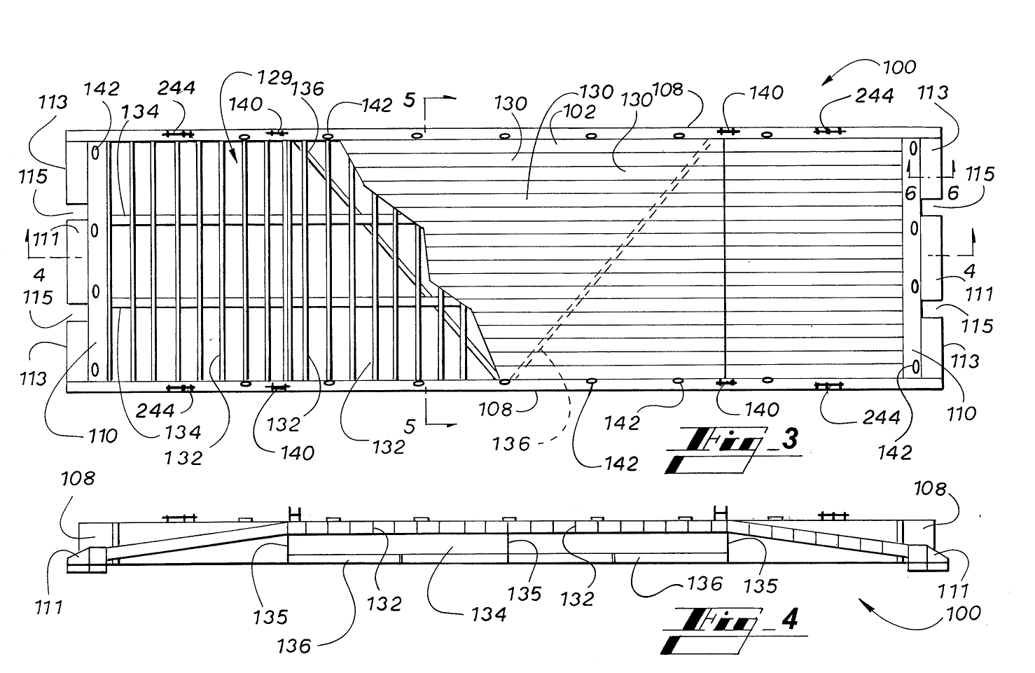

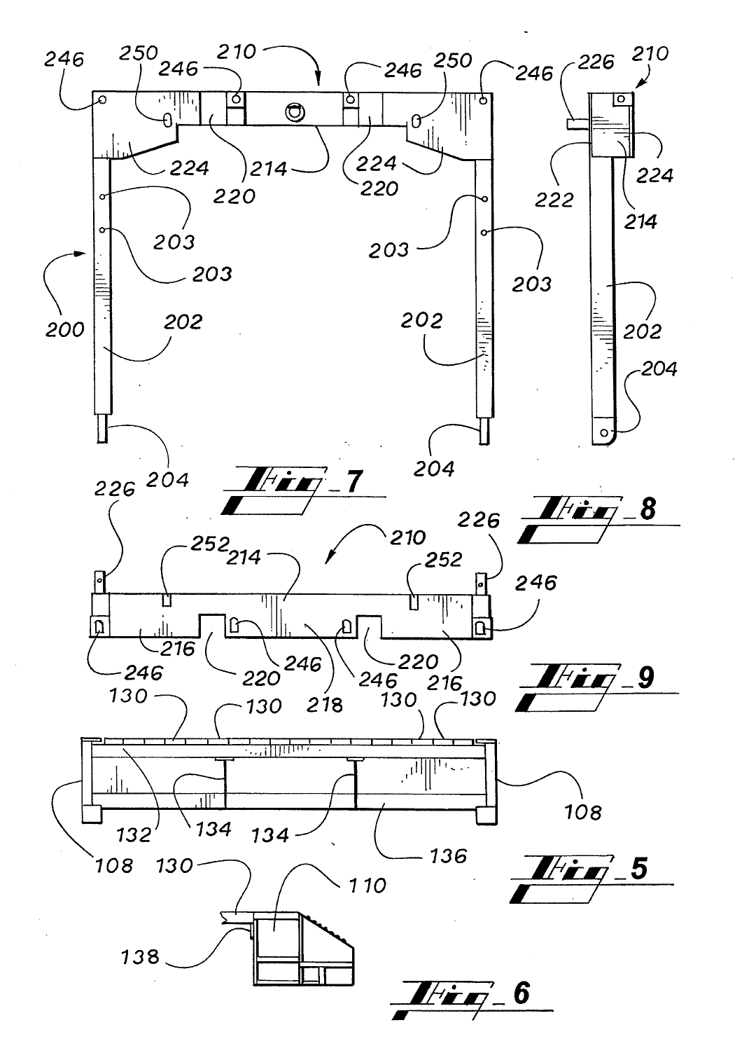

Referring to FIGS. 3-6, the cargo floor 102 preferably comprises longitudinal wooden planks 130 screwed to an underlying base support structure 129. The base support structure 129 comprises laterally extending joists 132 welded at their ends the side rails 108, and supported centrally by a longitudinal I-beams-type center rails 134. In addition, three laterally extending C-section members 135 connect the center rails 134 to each other and to the side rails 108, near the bottom. Diagonal braces 136 stiffen the entire support structure. The ends of the planks 130 adjacent each tubular end beam 110 rest on a flange 138 that is welded to the tubular end beam 110 (FIG. 6). Cargo tie-down rings 142 are provided around the perimeter of the base 100 and are hinged to the side rails 108 and to the tubular end beams 110.

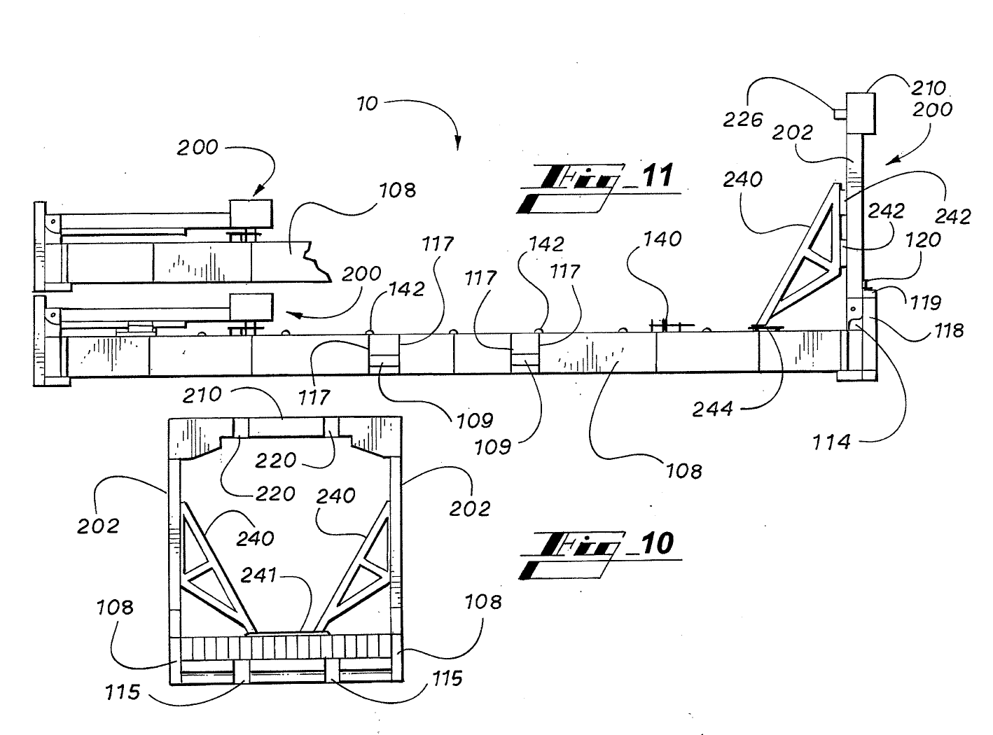

Referring again to FIGS. 1 and 2, upstanding hinge assemblies 112 at the ends of side rails 108 provide pivotal mounting points for corner posts 202 of end frames 200. Each hinge assembly 112 has a pair of spaced aperture plates 114 between which the lower end 204 of one of the corner post 202 is hinged by means of a hinge pin 116 (FIGS. 7 and 8). Hinge assembly 112 also has a post-like member 118 with an ISO corner casting 119 welded on top. The post-like member 118 provides an upright shoulder that serves as a rotational stop for the corner post 202 in its upright position. Each corner post 202 also carries a safety lock assembly 120, which connects to the corner casting 119 when the end frame 200 is upright. The safety lock assembly 120 ensures that the end frame 200 will not drop unintentionally from an upright position when its side brace frames 240 are not secure, such as during end frame erecting or folding procedures. The post-like members 118 also facilitate alignment during stacking of folded shipping platforms by providing corner casting apertures 121 for engaging semi-automatic twist-locks for stacking and shipping (FIGS. 10 and 12). The height of post-like members 118 is about 4 feet, 3 inches, which is half the height of the low-cube ISO container 20. Consequently, when two folded shipping platforms 10 are stacked on each other, the combined height of the two stacked open shipping platforms 10 equals the height of one low-cube ISO container 20.

Side brace frames 240, each of which is pivotally connected to a respective corner post 202 by a pair of hinges 242 (FIG. 10), stably support the end frames in an upright position when the lower ends of the side brace frames 240 are secured to the tops of the side rails 108. Securement of the end frames is provided by four brace frame lock shaft assemblies 244 carried by the side rails 108. Each lock shaft assembly 244 includes a slidable lock shaft releasably engageable with an aperture in the lower end of an adjacent side brace frame 240.

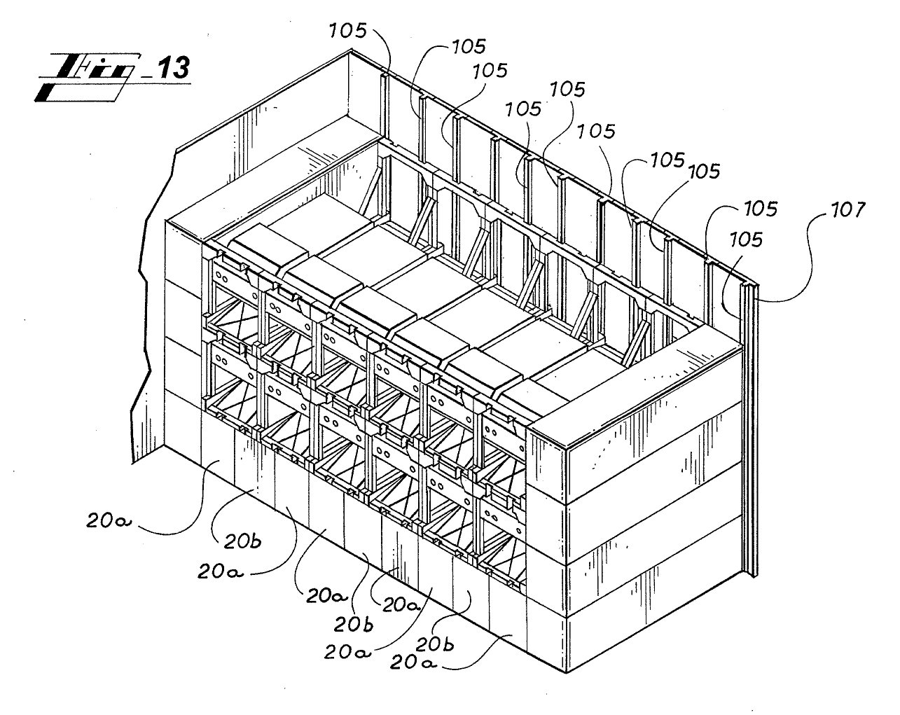

Referring to FIGS. 1, 2, and 7-11, a header assembly 210 interconnects the tops of the corner posts 202 of each end frame 200. Header assembly 210 comprises a number of members welded together to form a top beam 214 having two side projecting portions 216 and one central projecting portion 218. A D-ring 219 is attached to the central projecting portion 218. The D-ring 219 is used to raise and lower the end frame 200 between its folded position (FIGS. 11 and 12) and its upright position (FIGS. 1 and 2). Projecting portions 216 and 218 together define two upper cell guide slots 220 that are as wide as the lower cell guide slots 115 and are vertically aligned with the lower cell guide slots 115 so that one of the upper guide slots 220 also will always engage a T-shaped cell guide member 105 on a bulkhead 107 in the hold of a cargo ship. Inner and outer gusset plates 222 and 224 are welded to top beam 214 and to corner posts 202. A pair of aperture lock bars 226 project inwardly near the upper end of each end frame 200, and are adapted to be pinned to aperture side rail lock plates 140 on side rails 108 when the end frames 200 are released from brace lock shaft assemblies 244 and folded. When the end frames 200 are folded, the lower ends of each pair of side brace frames 240 preferably are stabilized by means of a stabilizing rod 241 (FIGS. 11 and 12) that couples the ends together.

In a standard configuration, the preferred height of the end frames 200 of the open shipping platform 10 is about 12 feet, 9 inches (with end frames upright), making the open shipping platform 10 one-and-one-half times the height of the low-cube ISO container 20, which is 8 feet, 6 inches high. Consequently, the combined height of two stacked shipping platforms 10 (25 feet, 6 inches) equals the combined height of three stacked ISO containers 20. In an alternative embodiment, the height of the end frames 200 can be adjusted to take into account cargo size and/or headroom factors. This can be accomplished by adjustably connecting the header assembly 210 to the corner posts 202 by means of, for example, inner posts (not shown) integral with the header assembly 210 that telescope into the upper ends of the hollow corner posts 202, each inner post secured by a pin that extends through aligned holes 203 in the telescoping members (FIG. 7).

Twist-lock apertures 146, 246, 250, and 252 are provided at strategic locations on the open shipping platform 10 to permit the open shipping platform 10 to mate with conventional ISO containers 20 and other open shipping platforms 10 and to permit loading and unloading by commonly used cranes and other loading devices. Referring to FIGS. 1, 2, and 11, each end of the base 100 has two outboard twist-lock apertures 146 formed near the corners of the base, and two inboard twist-lock apertures 146 formed near the corners of projection 111 (FIG. 2). Referring additionally to FIGS. 2 and 7, each header assembly 210 similarly has two outboard twist-lock apertures 246 formed near the corners of the header assembly 210, and two inboard twist-lock apertures 246 formed near the corners of projection 218. The horizontal spacing of these lower twist-lock apertures 146 and upper twist-lock apertures 246 is the same, viz., the horizontal spacing between the corner twist-lock apertures of 8 feet wide ISO containers 20. Thus, as seen in FIGS. 12-16, when the open shipping platforms 10 according to the invention are stacked above (or below) 8 feet wide ISO containers 20, two twist-lock apertures of each open shipping platform 10 are vertically aligned with the corner twist-lock apertures of ISO containers 20 below (or above). Consequently, all of the open shipping platforms 10 and the ISO containers 20 can be secured together, and the cell guide slots 115 and 220 of the open shipping platform 10 can accommodate the T-shaped cell guide members 105 of any thickness.

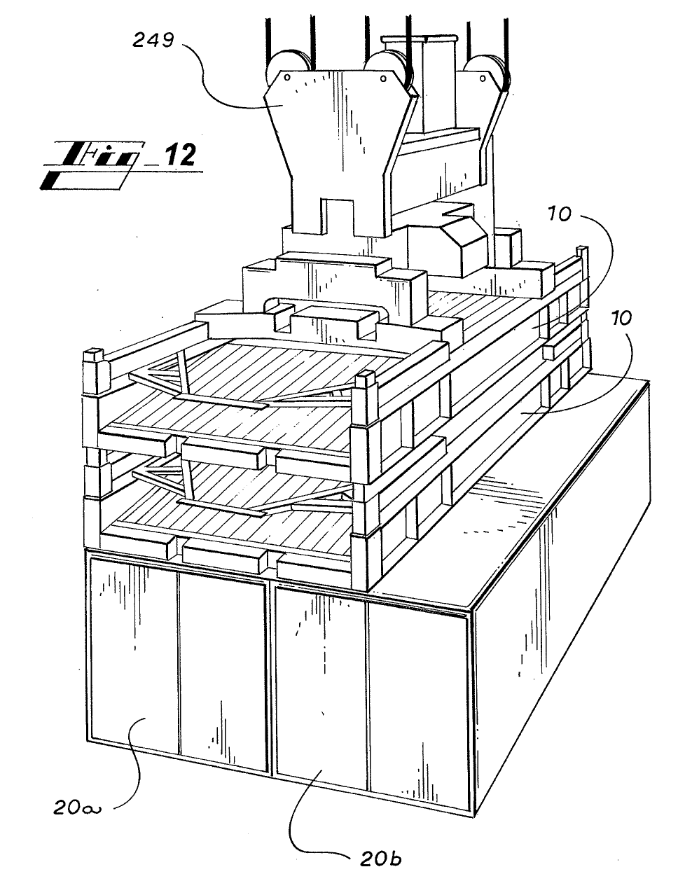

Two additional inboard twist-lock apertures 250 (FIG. 2) are provided below the top of each header assembly 210. These twist-lock apertures 250 face upwardly when the end frames 200 are folded and serve as lift points for a gantry crane 249 or other type of lift equipment (FIG. 12). Another pair of twist-lock apertures 252 are provided along the top of header assembly 210 for picking up the erected open shipping platforms 10 (FIG. 9). Twist-lock apertures 252 are located in such a way as to allow the gantry crane's spreader to clear the upper cell guide slots 220 in the header assembly 210.

In order to facilitate handling of the open shipping platform 10 by a forklift, optional forklift pockets 109 (FIG. 10) are formed by two open transverse tubes that extend into the width of the open shipping platform 10 and are welded to the side rails 108 and to the center rails 134. The forklift pockets 109 preferably are symmetrically arranged lengthwise of the open shipping platform 10, and are about 6 inches high, about 16 inches wide, and about 6 feet, 8¾ inches on center. Vertical stiffening ribs 117 are welded to the side rails 108 adjacent the forklift pockets 109 for added reinforcement.

Steel is the preferred material for most components of the open shipping platform 10 according to the invention, and welding is the preferred method of making virtually all of the permanent connections. One major exception is the cargo floor 102, which, as noted, preferably is made of pressure-treated wood planks 130 that are screwed to the underlying latterly extending joists 132. Screw fasteners facilitate replacement of broken and worn planks as needed. Other suitable materials and fastening methods may be used, as will be appreciated by those skilled in the art.

FIGS. 12-16 illustrate the stacking of the 12 feet wide open shipping platform 10 according to the invention atop 8 feet wide ISO containers 20. Particularly, with one longitudinal edge of the open shipping platform 10 aligned with one longitudinal edge of the first underlying ISO container 20a (FIG. 12), about one-third of the width of the open shipping platform 10 extends over one-half the width of the second adjacent and underlying ISO container 20b. While the central portion of the second adjacent and underlying ISO container 20b is not as strong vertically as its corner posts, the second adjacent and underlying ISO container 20b is not subject to damage by the overhanging portion of the open shipping platform 10 because of the high lateral bending stiffness of the base 100 of the open shipping platform 10. The bending stiffness of the base 100 results from its robust tubular end beams 110 (FIGS. 3 and 6), which are welded to side rails 108 and whose projections 111 and 113 directly overlie the corner posts of the first underlying ISO container 20a. Additional lateral bending stiffness of the entire open shipping platform 10 is afforded by the robust, gusseted upright end frames 200, which are solidly secured to the base 100. Thus, the open shipping platform 10 remains stable and well-supported at points spaced 8 feet apart primarily by the first underlying ISO container 20a, even though about one-third of the shipping platform's 10 width overhangs the second adjacent and underlying ISO container 20b.

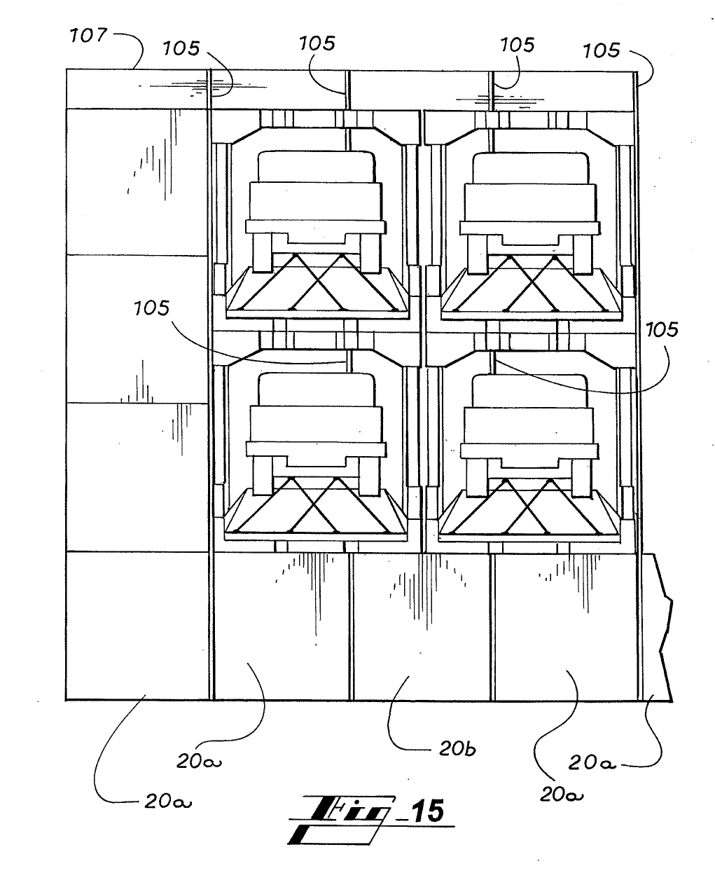

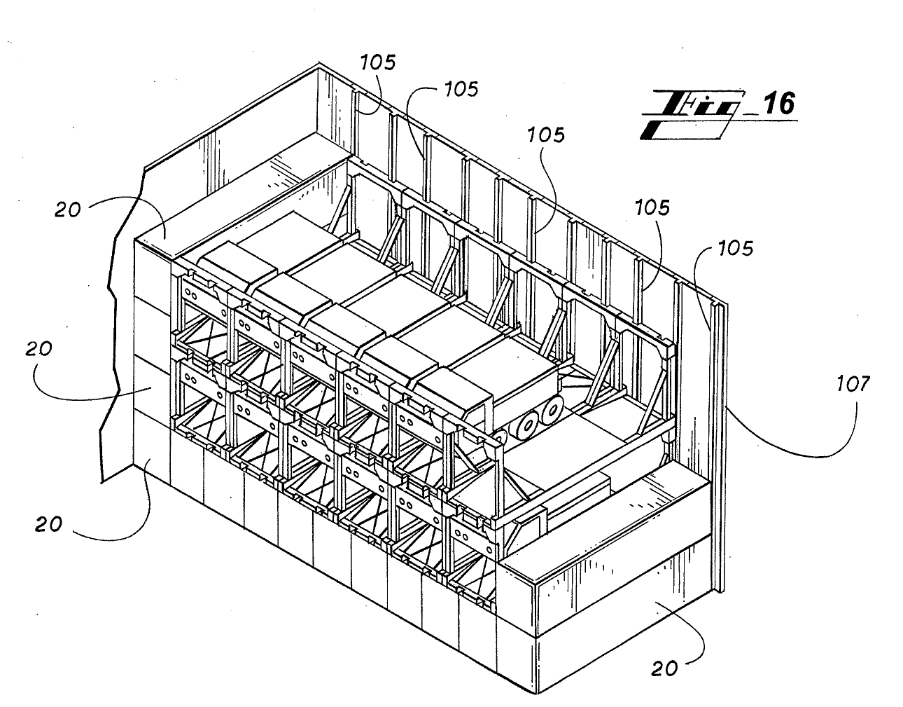

FIGS. 13 and 14 illustrate that two side-by-side shipping platforms 10 according to the invention span the width of three 8 feet wide ISO containers 20, and are well supported by the corner posts of the two outer ISO containers 20a while overhanging the middle ISO container 20b. These figures also illustrate that two stacked shipping platforms 10 according to the invention span the height of three stacked low-cube ISO containers 20. FIG. 16 shows a perspective view of the stack shown in FIG. 14 with the upper cell guide slots 220 engaging the T-shaped cell guide members 105 attached to the bulkhead 107.

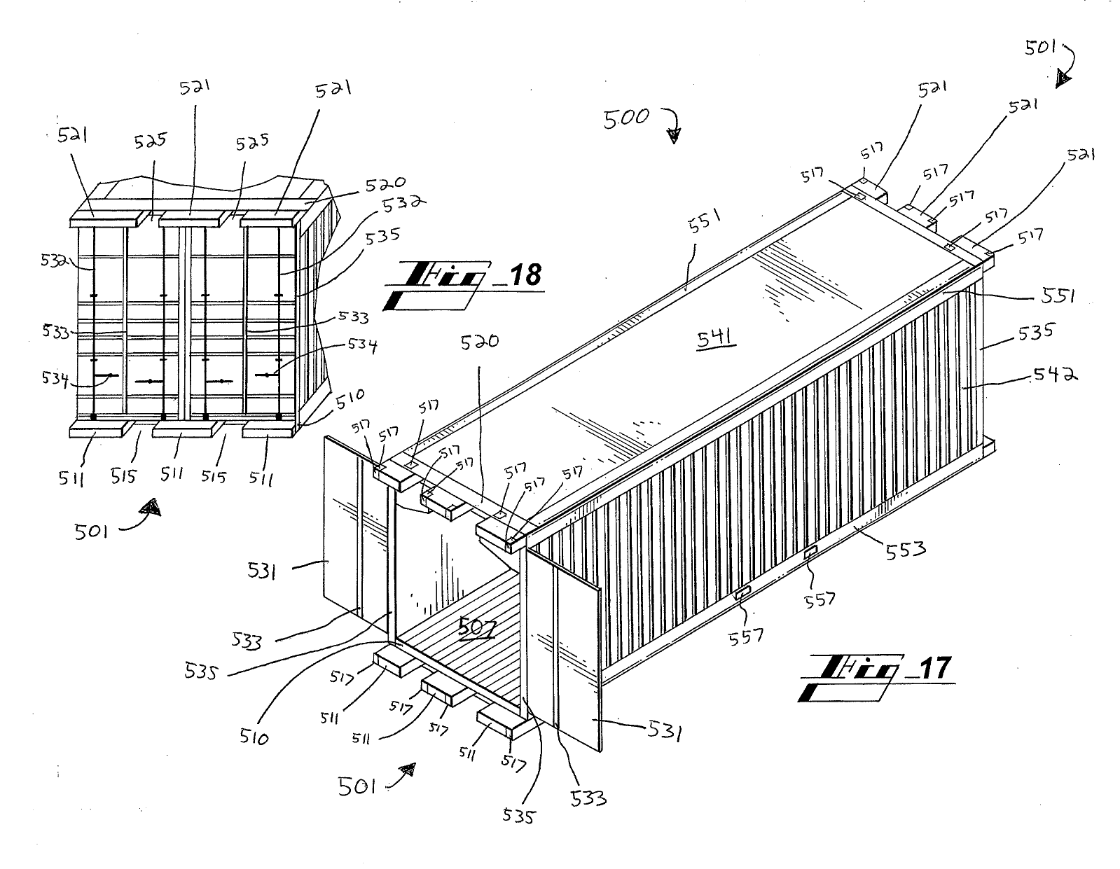

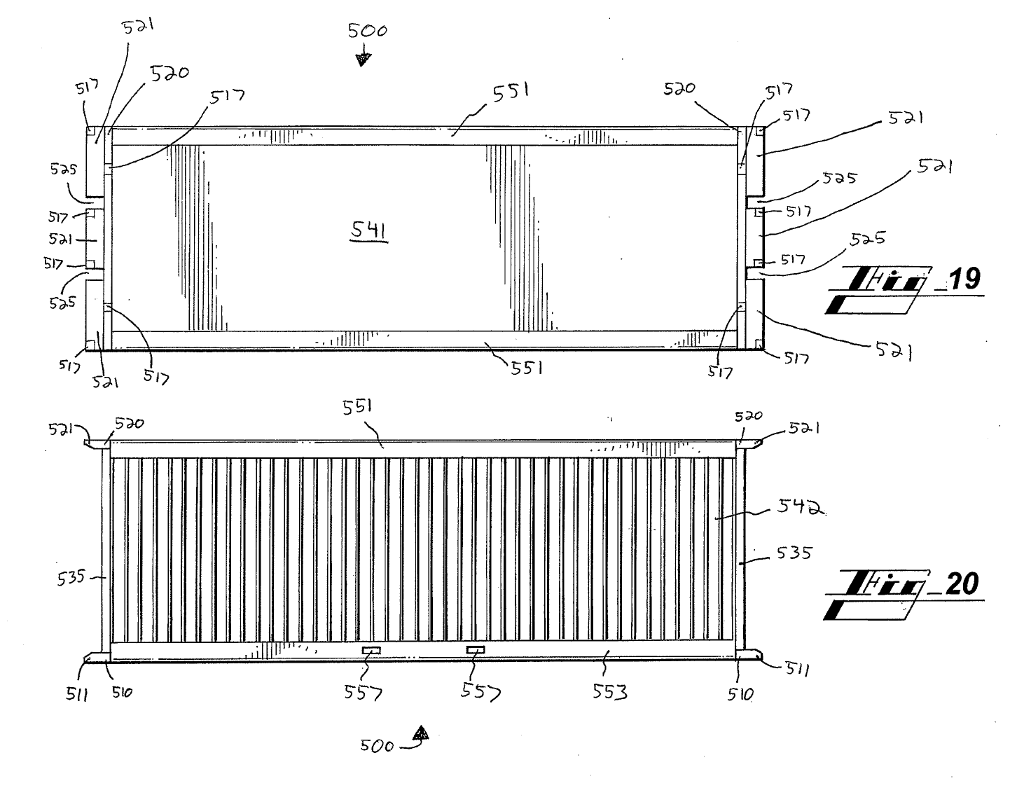

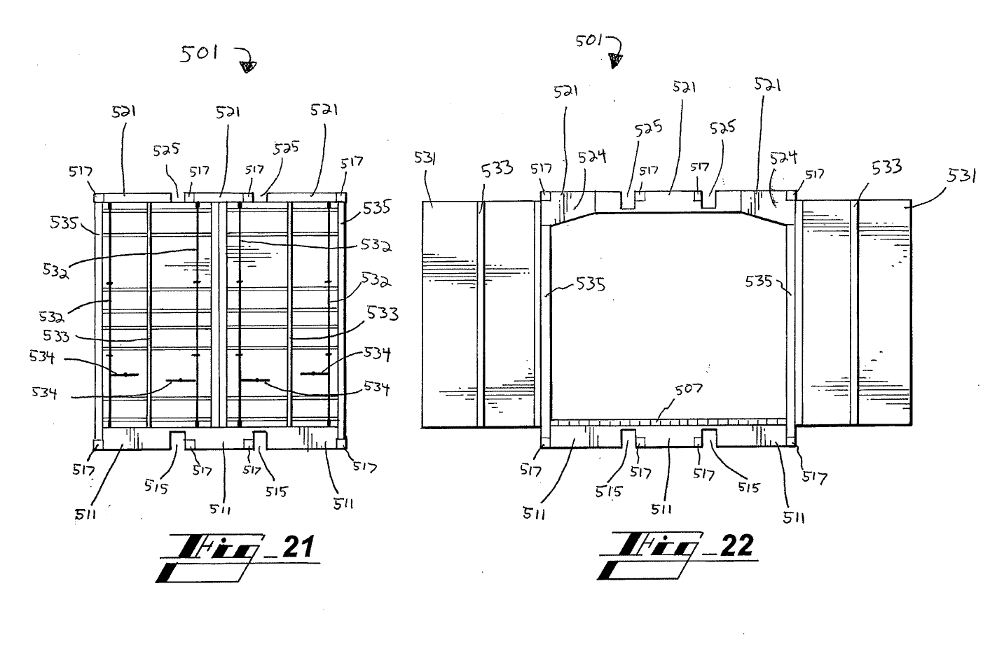

FIGS. 17-22 illustrate an enclosed shipping platform 500. This enclosed shipping platform 500 generally comprises two robust door frames 501 connected by upper side rails 551 and lower side rails 553. The enclosed shipping platform 500 further comprises a roof 541, two side panels 542, and a floor 507. Steel is the preferred material for most of the components, including the load-bearing door frames 501 and load-bearing doors 531. The roof 541 preferably comprises lightweight aluminum, however, which helps minimize the overall weight of the enclosed shipping platform 500. The side panels 542 preferably comprise corrugated steel. The floor 507 preferably comprises longitudinal wooden planks that are attached to an underlying base support structure (not pictured) by suitable means such as screws, adhesives, or other attachment means, as described above. The underlying base support structure is preferably similar to the base support structure 129 previously described with respect to FIGS. 3-6 of the open shipping platform 10. Floor 507 of the enclosed shipping platform 500, however, is preferably flat the entire length of the container 500 and does not have sloping end sections 106 as described with respect to the shipping platform embodiment 10. The underlying base support structure of the enclosed shipping platform 500 advantageously transfers the weight of the cargo to the lower tubular beams 510 of the end door frames 501. Welding is the preferred method for making most of the permanent connections with the exception of fastening the wooden planks to the underlying base support structure.

The enclosed shipping platform 500 is preferably 12 feet wide by 40 feet long with a height of 12 feet, 9 inches. As described above, these height and width dimensions are one-and-one-half times the height and width of a standard ISO container 20. Consequently, two enclosed shipping platforms 500 placed side-by-side will exactly span three standard ISO containers 20. Similarly, two enclosed shipping platforms 500 stacked on top of one another will span three standard ISO containers 20 in a vertical direction. The preferred length of the enclosed shipping platform 500 is 40 feet to accommodate the distance between bulkheads in a modem container ship. Certain embodiments of the enclosed shipping platform 500 can be longer than 40 feet, however, including lengths of 45 feet and 53 feet. Such embodiments can be stored above-deck on a ship or in oversized cargo holds.

Each load-bearing door frame 501 comprises left and right vertical corner posts 535, an upper tubular beam 520, and a lower tubular beam 510. Left and right load-bearing doors 531 are mounted in the door frame 501 on hinges so they may swing open and closed. The door frames 501 form robust load-bearing structures capable of bearing the considerable weight of other enclosed shipping platforms 500, shipping platforms 10, or conventional ISO containers 20 that are stacked on top of the enclosed shipping platform 500. In particular, the upper tubular beam 520 is capable of distributing weight to the load-bearing corner posts 535 and the load-bearing doors 531. Lower tubular beam 510 is a load-bearing member that can distribute weight appropriately when the enclosed shipping platform 500 is stacked in a cargo hold or on the deck of a ship. In some embodiments, the load-bearing doors 531 contain vertical stiffeners 533 that provide extra load-bearing support at certain points along the length of upper tubular beam 520 and lower tubular beam 510. In some embodiments, outer gusset plates 524 (FIG. 22) arid/or inner gusset plates (not pictured) are welded to upper tubular beam 520 and corner post 535 to provide additional support.

In some embodiments, the doors 531 form a watertight seal when they are closed. This feature completely protects the cargo from inclement weather and from the spray of seawater during shipping. In addition, the enclosed nature of the enclosed shipping platform 500 helps to prevent theft or loss during the loading, unloading, and shipping of cargo. The doors 531 preferably have locking rods 532 and door latches 534 that permit the doors 531 to be locked during transit. In certain embodiments, security seals can be applied to the doors 531 to secure the cargo during transit, loading, and unloading. These security seals can help prevent theft or loss of cargo and protect against the smuggling of people or contraband cargo. The enclosed nature of the enclosed shipping platform 500 also hides sensitive cargo from view.

Each door frame 501 contains lower cell guide projecting portions 511 that are attached to the lower tubular beam 510 at certain intervals, thus creating lower cell guide slots 515 at regular intervals. Likewise, each door frame 501 contains upper cell guide projecting portions 521 that are attached to the upper tubular beam 520 at certain intervals, thus creating upper cell guide slots 525 at regular intervals. Welding is the preferred method for attaching the cell guide projecting portions 511, 521 to the lower and upper tubular beams 510, 520, respectively. The cell guide slots 515, 525 are spaced and sized such that they can engage the T-shaped cell guide members 105 on a bulkhead 107 in the hold of a cargo ship (FIGS. 13-16). Specifically, for a 12 feet wide enclosed shipping platform 500, the cell guide slots 515, 525 are about 12 inches deep, about 12 inches wide, and about 5 feet on center, thus allowing them to engage the T-shaped cell guide members 105 on a cargo ship's bulkhead 107.

Twist-lock apertures 517 are provided at strategic locations on the enclosed shipping platform 500 to permit the enclosed shipping platform 500 to mate with conventional ISO containers 20, open shipping platforms 10, other enclosed shipping platforms 500, and the bulkhead 107. The twist-lock apertures 517 also permit loading and unloading by commonly used cranes and other loading devices. Outboard twist-lock apertures 517 are located near the corner posts 535 and inboard twist-lock apertures 517 are located at a distance eight feet from either side of the enclosed shipping platform 500. This eight feet spacing allows the twist-lock apertures 517 to mate with standard ISO containers 20 that are eight feet in width as well as bulkheads 107 that are configured to engage twist-lock apertures 517 at eight feet intervals.

Optional forklift pockets 557 may be placed along the lower side rails 553 of the enclosed shipping platform 500. The forklift pockets 557 preferably comprise open transverse tubes that extend into the lower side rails 553. The forklift pockets 557 preferably are symmetrically arranged lengthwise of the enclosed shipping platform 500, and are about 6 inches high, about 16 inches wide, and about 6 feet, 8¾ inches on center. Vertical stiffening ribs (not shown) may be welded to the lower side rails 553 adjacent the forklift pockets 557 for added reinforcement.

As described above in relation to FIGS. 13-16, the enclosed shipping platform embodiment 500 will fit in a conventional cargo hold in a manner similar to the open shipping platform 10. Specifically, when two side-by-side enclosed shipping platforms 500 are stacked on top of three 8 feet wide ISO containers 20, the outside corner posts 535 of the enclosed shipping platforms 500 will be well supported by the outside corner posts of the two outer ISO containers. The inner corner posts of the supporting ISO containers will support the lower tubular beams 510 of the enclosed shipping platforms 500.

Because the enclosed shipping platform 500 is not adapted for folding, it can be constructed without some of the heavier components of the open shipping platform 10. Specifically, the enclosed shipping platform 500 does not contain side brace frames 240, hinge assemblies 112, aperture lock bars 226, brace lock shaft assemblies 244, aperture side rail lock plates 140, or any other hardware adapted for folding or bracing the end frames required by the open shipping platform 10. Furthermore, the enclosed shipping platform 500 preferably has a flat floor 507 so the laterally extending joists and center rails of the base support structure have less thickness than the joists 132 and center rails 134, respectively, of the base support structure 129 of the open shipping platform 10. In addition, because the enclosed shipping platform 500 comprises load-bearing doors 531 in each end door frame 501, the load-bearing corner posts 535 can be constructed of a thinner material than the corner posts 202 of the open shipping platform 10.

This lighter weight construction of the enclosed shipping platform 500 allows the enclosed shipping platform 500 to be approximately 4,000 to 5,000 pounds lighter than the open shipping platform 10. In addition, the load-bearing doors 531 provide additional load-bearing capabilities to the enclosed shipping platform 500 such that the enclosed shipping platforms 500 can be stacked five high in a ship's hold (with the support of a surrounding bulkhead) and three high on a ship's deck or on a loading dock.

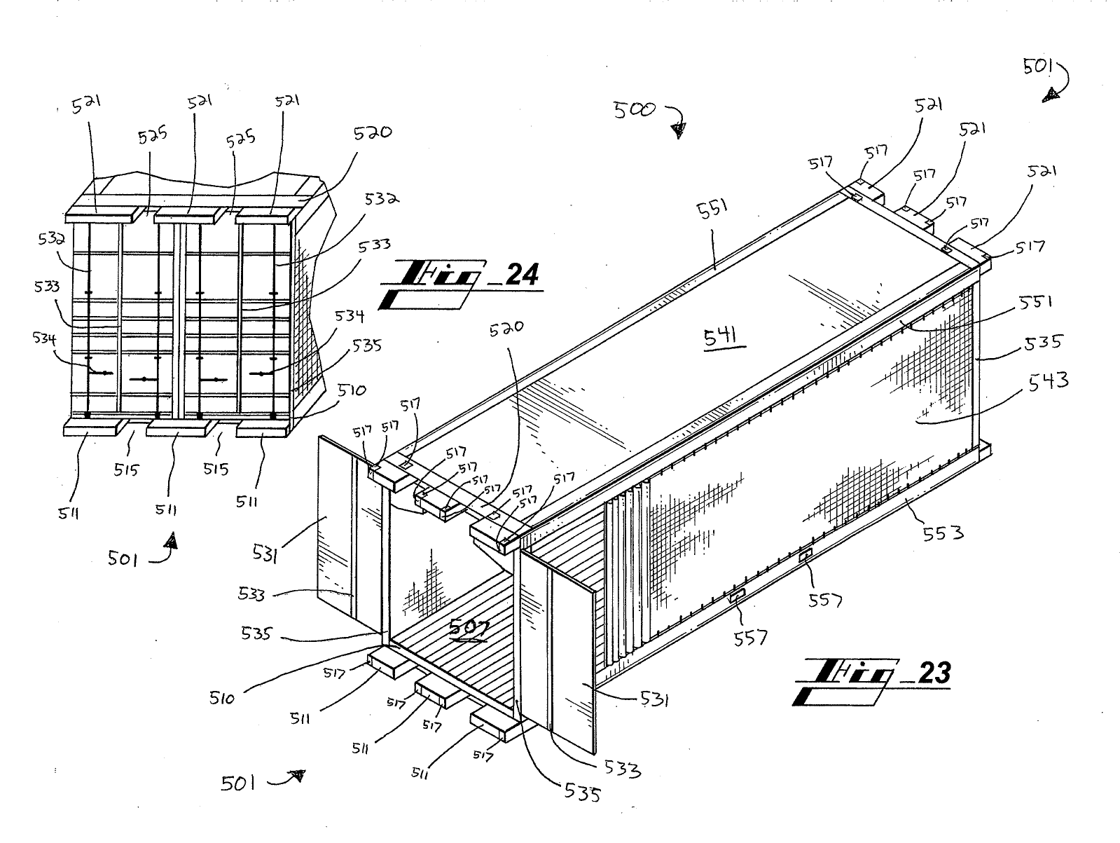

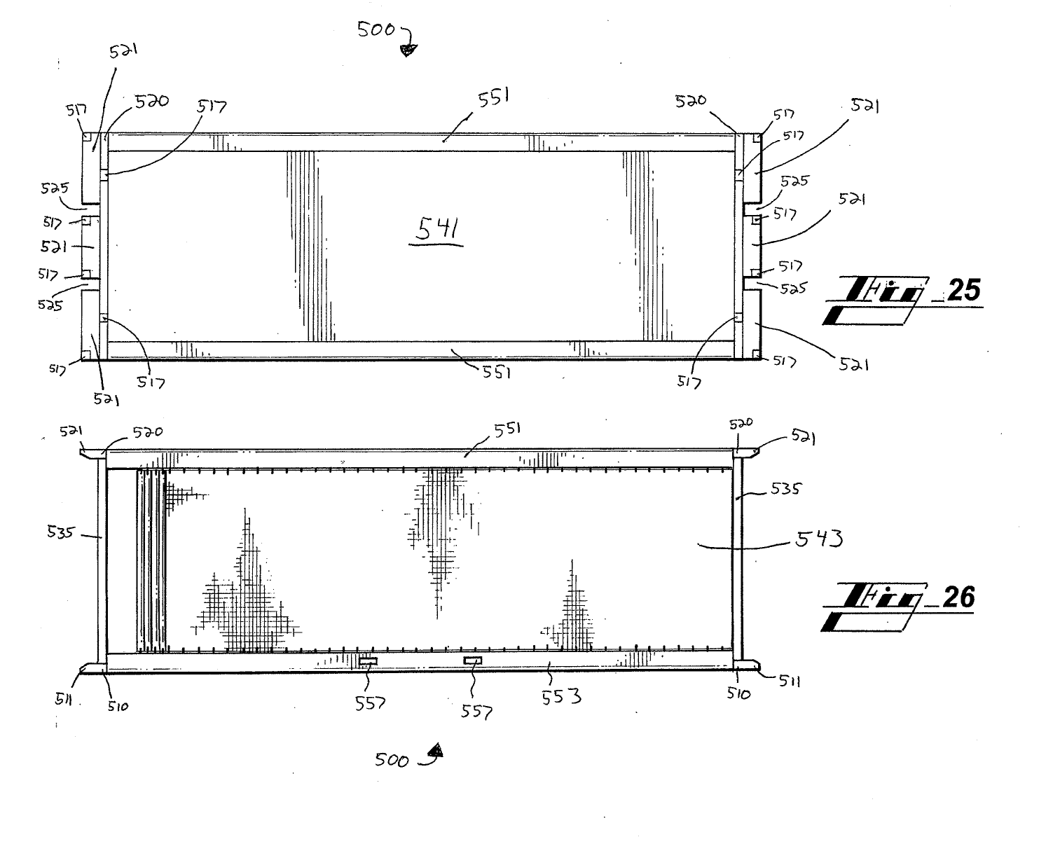

FIGS. 23-26 illustrate an alternative embodiment of the enclosed shipping platform 500 with one or two movable side panels, such as a movable side panel 543, that can be opened and closed to permit side loading of the enclosed shipping platform 500. Preferably, the enclosed shipping platform 500 will have only a single movable side panel 543 with the remaining side panel comprising a non-movable material such as corrugated steel that is fixed in place and attached to corner posts 535 at both ends of the enclosed shipping platform 500. In alternate embodiments, both side panels are movable.

The movable side panel 543 preferably comprises a foldable, rugged material such as vinyl or canvas with optional reinforcing material such as steel fibers. Preferred embodiments of the movable side panel 543 include the Curtainside™ family of movable curtains from Sliding Systems, Inc. of Haslett, Mich. The movable side panel 543 can slide open from the left or right similar to a curtain. FIG. 23 illustrates the movable side panel 543 partially opened from the left side of the enclosed shipping platform 500. Once open, the movable side panel 543 allows access to the enclosed shipping platform 500 along the entire length of the enclosed shipping platform 500. Advantageously, this alternative embodiment permits cargo in the center of the enclosed shipping platform 500 to be removed without unloading the surrounding cargo. In addition, the movable side panel 543 facilitates the rapid loading and unloading of cargo because it allows for the simultaneous access to the entire length of the enclosed shipping platform 500.

While this invention has been described with reference to preferred embodiments thereof, it is to be understood that variations and modifications can be affected within the spirit and scope of the invention as described herein and as described in the appended claims.

I claim:

1. A shipping platform adapted for stacking with cargo containers, wherein the cargo containers have a container width, a container length, and a container height, and wherein the cargo containers have structural corner posts, the shipping platform comprising:
a. a base having a base length and a base width, and wherein the base has rails extending along the base length and end beams, connected to the rails, and extending laterally along the base width at each end of the base; and
b. end frames secured at each end of the base and each end frame having an end frame height and an end frame width, wherein each end frame has end frame corner posts and an end frame header mounted between the corner posts and extending laterally along the frame width,
wherein the base width is longer than the cargo container width so that when the shipping platform is positioned atop a cargo container, the container corner posts support the end beams of the shipping platform with a portion of the base extending beyond the container width and wherein the end beams have sufficient strength to support the portion of the base extending beyond the container width.

2. The shipping platform of claim 1, wherein the end beam has a first end and a second end and wherein the first end is in alignment with the cargo container corner posts and the second end is transversely offset from the cargo container corner posts when the shipping platform is stacked atop a cargo container.

3. The shipping platform of claim 2, wherein the base width is 1.5 times the cargo container width.

4. The shipping platform of claim 1, wherein the end frame height is variable.

5. The shipping platform of claim 4, wherein the end frame height is 1.5 times the container height.

6. The shipping platform of claim 1, wherein the corner posts of the end frames are pivotally mounted to the base by means of a hinge assembly to allow the end frames to be folded onto the base and wherein the hinge assembly includes post-like members, which when the end frames are folded, define a folded height for the shipping platform.

7. The shipping platform of claim 6, wherein the end frames are secured in an upright position by means of side braced frames releasably connecting the corner posts of the end frames to the side rails of the base and wherein the side braced frames are restrained by a stabilizing rod when the side braced frames are disconnected from either the corner posts or the side rails.

8. The shipping platform of claim 6, wherein the folded height is 0.5 times the container height.

9. The shipping platform of claim 6, wherein the hinge assembly includes a safety lock to maintain the end frames in an upright position.

10. The shipping platform of claim 6, wherein the post-like members engage the corner posts of the end frames when the end frames are in an upright position to stop rotation of the corner posts in the hinge assembly.

11. The shipping platform of claim 6, wherein the post-like members have apertures for engaging semi-automatic twist-locks for stacking and shipping folded shipping platforms.

12. The shipping platform of claim 1, wherein the cargo containers and the shipping platform are adapted for stacking in a hold of a ship having bulkheads with spaced cell guide members attached to and extending vertically along the bulkheads and wherein the end beams and the end frame headers of the shipping platform have vertically aligned slots spaced to match spacing between the cell guide members.

13. The shipping platform of claim 1, wherein the base has transversely extending forklift pockets.

14. An oversized enclosed shipping platform adapted for stacking with standard cargo containers, wherein the standard cargo containers have a standard cargo container width, a standard cargo container length, and a standard cargo container height, and wherein the standard cargo containers have structural corner posts, the enclosed shipping platform comprising:
a. a base having a base length and a base width, and wherein the base has rails extending along the base length and lower beams, connected to the rails, and extending laterally along the base width at each end of the base,
b. door frames secured at each end of the base and each door frame having a door frame height and a door frame width, wherein each door frame has door frame corner posts, a door frame upper beam mounted between the corner posts and extending laterally along the frame width, and load bearing doors mounted inside the door frame, wherein the load bearing doors are capable of supporting weight from the upper beam and transferring said weight to the lower beam,
c. two side panels connected to the door frame corner posts and the base, and
d. a roof connected to the door frame upper beams and the side panels,
wherein the base width is longer than the standard cargo container width so that when the enclosed shipping platform is positioned atop a standard cargo container, the standard cargo container corner posts support the lower beams of the enclosed shipping platform with a portion of the base extending beyond the standard cargo container width and wherein the lower beams have sufficient strength to support the portion of the base extending beyond the standard cargo container width.
